(19) United States
(12) Patent Application Publication
(10) Pub. No.: US 2005/0246470 A1
(43) Pub. Date: Nov. 3, 2005

(54) Wireless docking station

(76) Inventor: David G. Brenner, Plano, TX (US)

Correspondence Address: CARSTENS YEE & CAHOON, LLP, P O BOX 802334, DALLAS, TX, 75380, US

(21) Appl. No.: 11/117,210

(22) Filed: Apr. 28, 2005

Related U.S. Application Data
(60) Provisional application No. 60/565,954, filed on Apr. 28, 2004.

(51) Int. Cl. G06F 13/00

(52) U.S. Cl. 710/303

(57) ABSTRACT

With the rapid innovation in wireless technology, greater bandwidth is now available. This invention proposes to use the much greater wireless bandwidth available with ultrawideband (UWB) technology, to replace the current expensive solution for laptop port replication using hardwired connections. First, a wireless interface between the laptop and the port replicator will no longer require the expensive, high-pincount docking station connector currently in use in today's products. This will increase reliability of the docking system, and decrease cost of the solution. Second, a wireless dock will allow the laptop user to more quickly associate their computer with the docking station and connected peripherals merely by placing the laptop in proximity with the dock. Third, the bandwidth of the UWB wireless connection can be superior to that of a USB solution, with data rates exceeding 1 Gbps. When these advantages are combined, the UWB-powered docking station will offer a significant alternative to the current approach for laptop docking while protecting the customer investment in peripherals.

### CROSS REFERENCE TO RELATED APPLICATION

This application is a non-provisional application and claims priority back to U.S. Provisional Application Ser. No. 60/565954 filed on Apr. 28, 2004 entitled “Wireless Docking Station/Wireless Port Replicator”.

### TECHNICAL FIELD OF THE INVENTION

The present invention relates to a docking station to wirelessly connect a laptop computer to a peripheral such as a monitor, keyboard or mouse. The wireless docking station eliminates the need for the physical connector typically located on rear panel of the laptop.

### BACKGROUND OF THE INVENTION

Laptop computers offer mobility to many working professionals. A laptop is generally light weight but has the drawbacks of a reduced size monitor and keyboard. Once the user returns to his office, he would usually prefer to continue work with a larger monitor and a full size keyboard. One solution is a docking station. The laptop computer is connected to a docking station that provides connectivity to other peripherals such as a larger monitor, a printer, keyboard, mouse, or even the office local area network. A physical connection is made between the laptop and the docking station, at which time the docking station provides the necessary ports to connect to those peripherals.

FIG. 1 provides a block diagram of the prior art physical docking system 100. The system 100 includes a laptop 102 and the docking station 104. The docking station can also be referred to as a port replicator because it replicates many of the ports located on the back of the laptop. Laptop computers today utilize a physically-connected mechanical/electrical solution to attach a standard set of peripherals including a printer 110, a display 112 (monitor), external keyboard 114, external mouse 116, or other pointing device, and/or LAN connector 118. The primary purpose of the replicator is to provide a fast and convenient mechanism to allow the laptop computer to attach or detach from these peripheral devices without having to physically disconnect each of the respective cables from the computer. While the replicator solutions available today provide a certain level of convenience in regards to fast connect/disconnect, the problem with these devices concerns both cost and reliability. The invention proposes to address both of these primary concerns while also providing added convenience.

Present day replicator architectures typically extend the internal PCI bridge chipset from inside the laptop to an external box, which then connects to each of the peripherals using legacy and/or modern interfaces. These legacy connections are shown in FIG. 2A which illustrates the rear panel 202 of laptop computer 200 having a monitor 204. The connections can include popular connections such as USB ports 202, IEEE 1284 (Centronics) parallel 208, RS232 serial 212, PS/2-style mouse and keyboard connector 214, VGA and/or DVI-style display (monitor) connections 216, IEEE 1394 (Firewire), and even modem flash card ports such as Sony's Memorystick, Compact Flash, and others. The interface between the docking station and the laptop typically uses a specialized, high-pincount connector assembly 210 that includes an alignment feature and even hot-plug capability. Because of the complexity of this connector, the current replicator solution is fairly expensive.

To compound the problem list, the frequent dock/undock (insert/uninsert) operations can cause failure of the docking connector itself. FIG. 2B provides a view of a standard docking station 250. The station has a surface 258 that might include alignment grooves 256. A central hub 252 contains the mating connector 254 for the assembly 210 discussed above. In other words, the user must align the laptop with the replicator before physically engaging it. A misalignment can cause pin damage and ultimately failure of the replicator port. A rear view of the hub 252 is provided in FIG. 2C and it includes many if not more of the same ports located on the back of the laptop. These are used to connect to the printer 260, monitor 262, keyboard 264, or LAN 266.

Another current port replicator solution does not use a PCI-like connector, but rather utilizes a USB connection between the laptop and the peripherals. The key problem here is one of bandwidth, as the USB interface is not capable of supporting the combined data rates of the various peripherals, particularly the video for the display. So while this approach addresses some of the cost and reliability challenges, it does not address the performance needs for a complete docking solution and all attached peripherals. Therefore, a need exists for a method of creating connectivity with the base station without the need for physically connecting the laptop to the docking station. Such a solution must provide the same results and offer the necessary bandwidth for today's increased data rates.

### SUMMARY OF THE INVENTION

With the rapid innovation in wireless technology, greater bandwidth is now available. This invention proposes to use the much greater wireless bandwidth available with ultrawideband (UWB) technology, now that the FCC has authorized its public use. The current expensive solution for laptop port replication using hardwired connections can be replaced with a UWB wireless connection. This approach is superior to the current solution in a number of ways. First, a wireless interface between the laptop and the port replicator will no longer require the expensive, high-pincount docking station connector currently in use in today's products. This will increase reliability of the docking system, and decrease cost of the solution. Second, a wireless dock will allow the laptop user to more quickly associate their computer with the docking station and connected peripherals merely by placing the laptop in proximity with the dock rather than taking the time to ensure a precise mechanical connection is established (as is currently required). This also allows the docking station to be placed in a convenient location other than just on the user's desktop. Third, the bandwidth of the UWB wireless connection can be superior to that of a USB solution, with data rates capable of exceeding 1 Gbps. When these advantages are combined, the UWB-powered docking station will offer a significant alternative to the current approach for laptop docking while protecting the customer investment in peripherals.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of current docking station/port replicator;

FIG. 2A illustrates the rear panel of a typical laptop, showing the real estate used for connection to a prior art docking station;

FIGS. 2B and 2C provide more detailed views of prior art docking stations.

FIG. 3 is a block diagram of UWB-Powered Docking Station/Port Replicator;

FIG. 4 is a block diagram of laptop side of Wireless Docking Solution;

FIG. 5 is a block diagram of docking side of Wireless Docking Solution; and

FIG. 6 illustrates a hybrid system that allows a dongle to be placed into existing hardware to produce the UWB wireless connection between a legacy laptop and/or a legacy docking station.

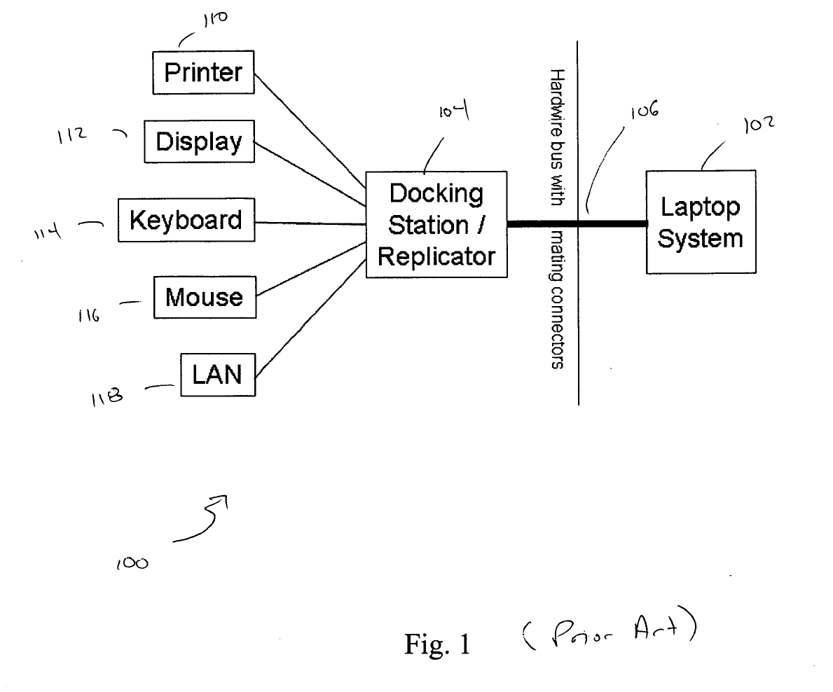

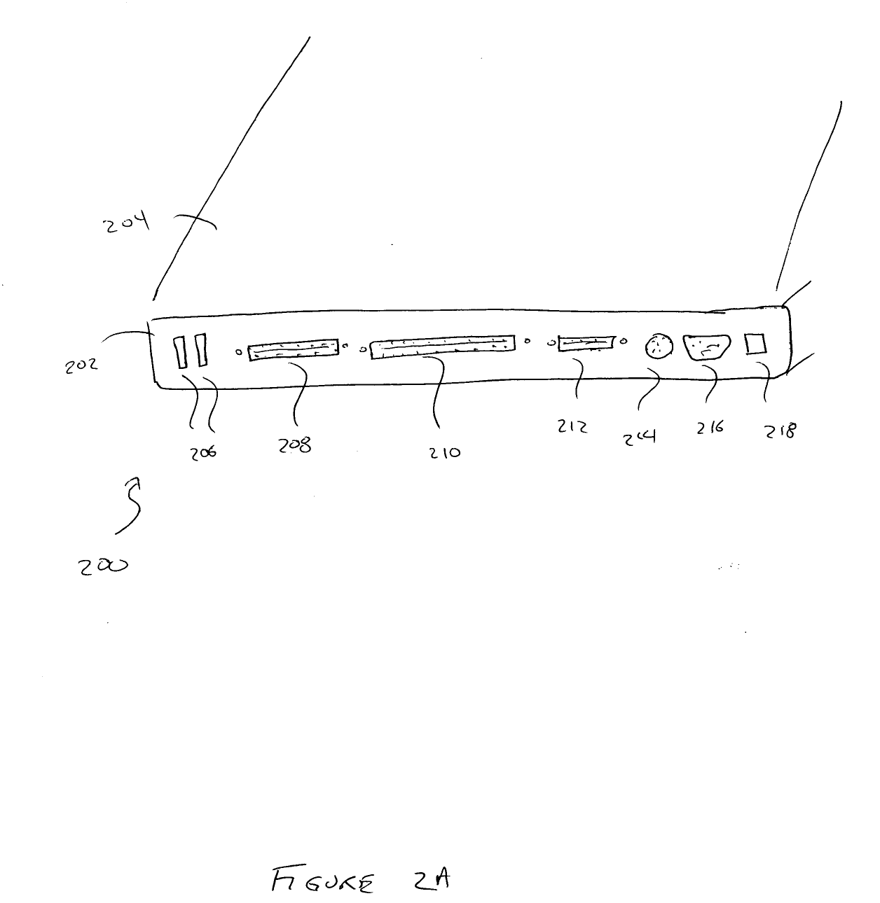

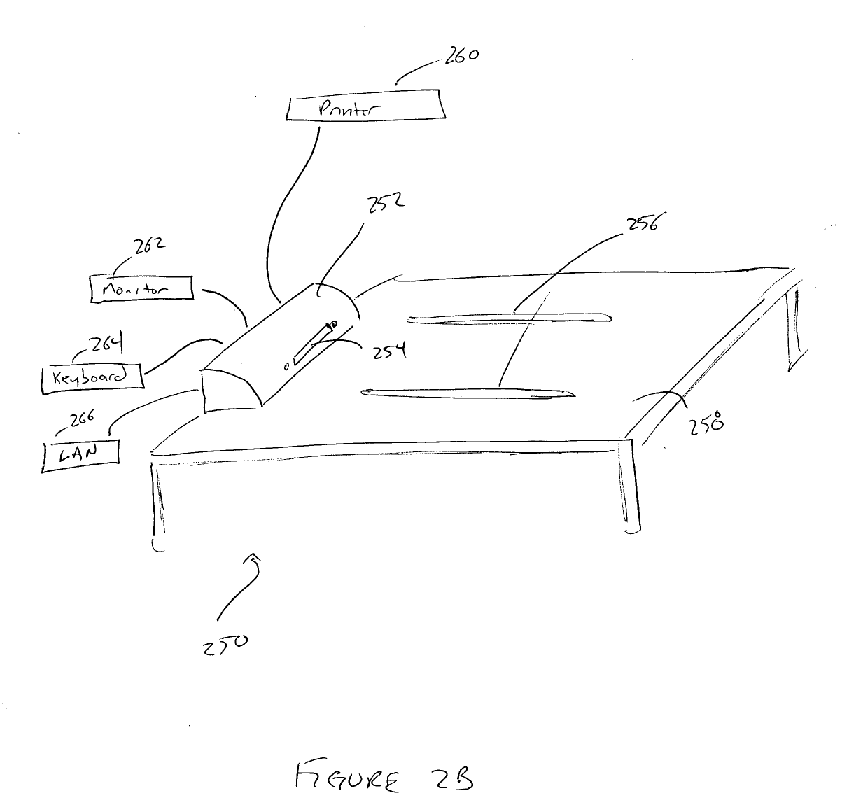

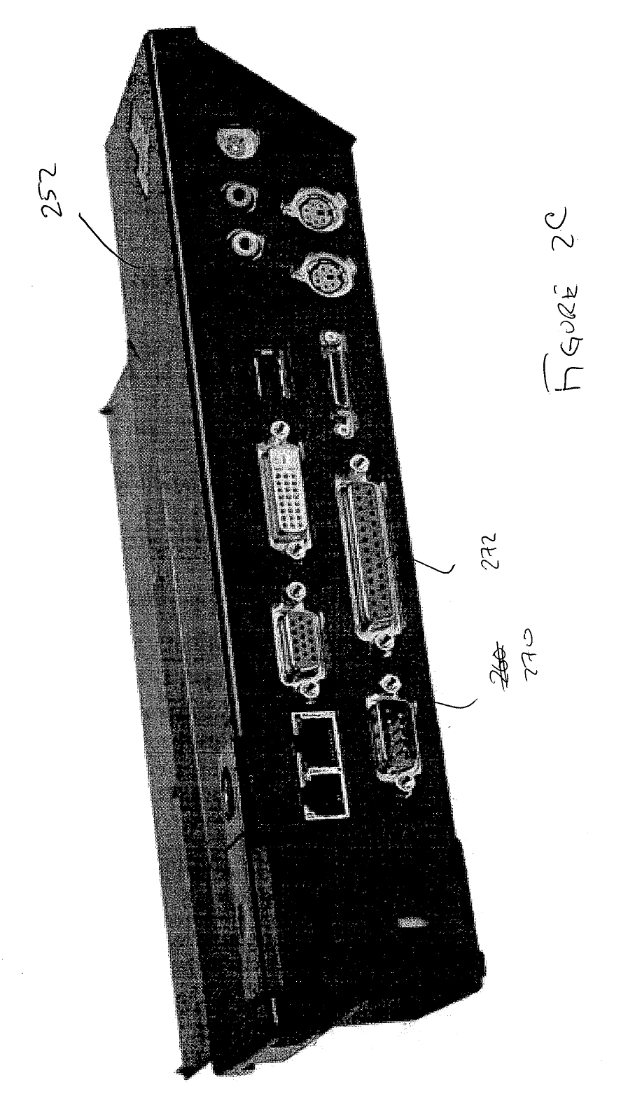

### DETAILED DESCRIPTION OF THE INVENTION

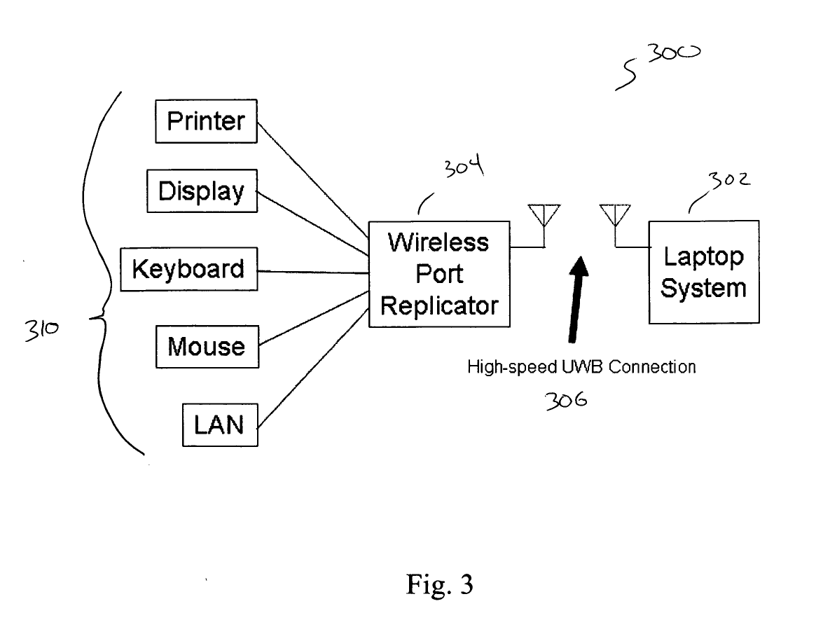

Greater bandwidth allows a laptop user to connect to peripherals without the need for cables. For example, it is common for a laptop computer to be placed on a docking station once the user returns to an office. With the rapid innovation in wireless technology, greater bandwidth is now available. This invention proposes to use the much greater wireless bandwidth available with ultrawideband (UWB) technology. The current expensive solution for laptop port replication using hardwired connections can be replaced with a UWB wireless connection as shown in FIG. 3 in which a laptop 302 and a wireless port replicator 304. A high speed ultrawideband connection 306 is established between the two.

This approach is superior to the current solution in a number of ways. First, a wireless interface between the laptop 302 and the port replicator 304 will no longer require the expensive, high-pincount docking station connector currently in use in today's products. This will increase reliability of the docking system, and decrease cost of the solution. Second, a wireless dock 304 will allow the laptop user to more quickly associate their computer with the docking station and connected peripherals 310 merely by placing the laptop in proximity with the dock rather than taking the time to ensure a precise mechanical connection is established (as is currently required). Third, the bandwidth of the UWB wireless connection can be superior to that of a USB solution, with data rates exceeding 1 Gbps. When these advantages are combined, the UWB-powered docking station will offer a significant alternative to the current approach for laptop docking while protecting the customer investment in peripherals.

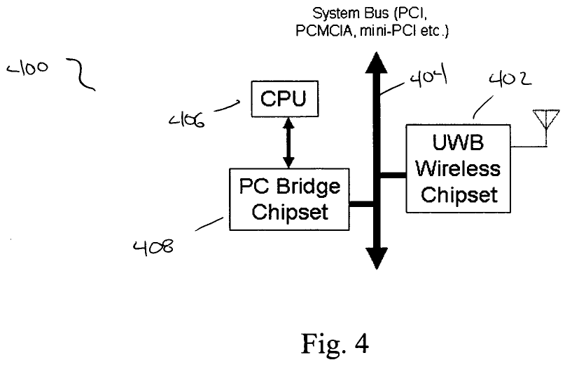

The design of the invention may be implemented in the following described manner, or in similar approaches which achieve the same basic connectivity. Referring to FIG. 4, on the laptop, an ultrawideband wireless chipset 402 is connected to the computer via an internal system bus 404, such as PCI, PCMCIA, or mini-PCI. This provides the host side of the wireless connection. The wireless chipset communications to the CPU 406, memory, and/or other peripherals through a standard PC bridge chipset 408.

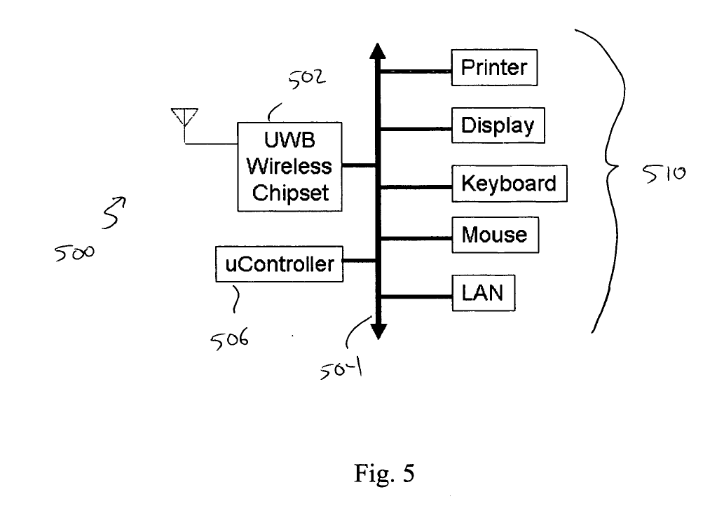

A similar approach is taken on the docking station/port replicator side 500 of the system as shown in FIG. 5. In this case, the UWB chipset 502 connects to a system bus 504 in the docking station. Data transfers and bus arbitration may be handled by a microcontroller 506 or microprocessor. The various connections 510 and any combinations thereof that may be supported by the docking station, such as display controller, keyboard, mouse, LAN, etc. will connect to the bus. All of these functions 500 may also be integrated into a single, common I/O chipset including the UWB chipset 502. The approach to connecting the various peripherals may vary from system to system, and may involve the use of an additional PC bridge chip in the dock. The microcontroller or microprocessor in the wireless docking station will also be used to run the requisite firmware to handle the UWB bridge chip and other I/O device initialization, data transfers, and control.

In this invention, the UWB radio combination, comprising of the laptop side of the connection as well as the docking station side, together provide a ‘virtual bus’ that allows the peripherals connected to the dock to appear as though they are locally attached to the laptop system. The device driver for the laptop-side UWB chipset needs to provide bridging functions between the laptop and dock as well as to arbitrate the various data streams and data rates of the connected peripherals. Since UWB technology can provide a time division (time slot) mechanism, bandwidth across the wireless channel for each of the different dock peripherals can be scheduled according to their individual needs. The laptop driver will also provide a mapping function for each of these peripheral devices in the dock to the laptop operating system (OS) such that the OS has visibility for each device and can handle both control and data operations as though the wireless dock peripherals were directly attached to the laptop.

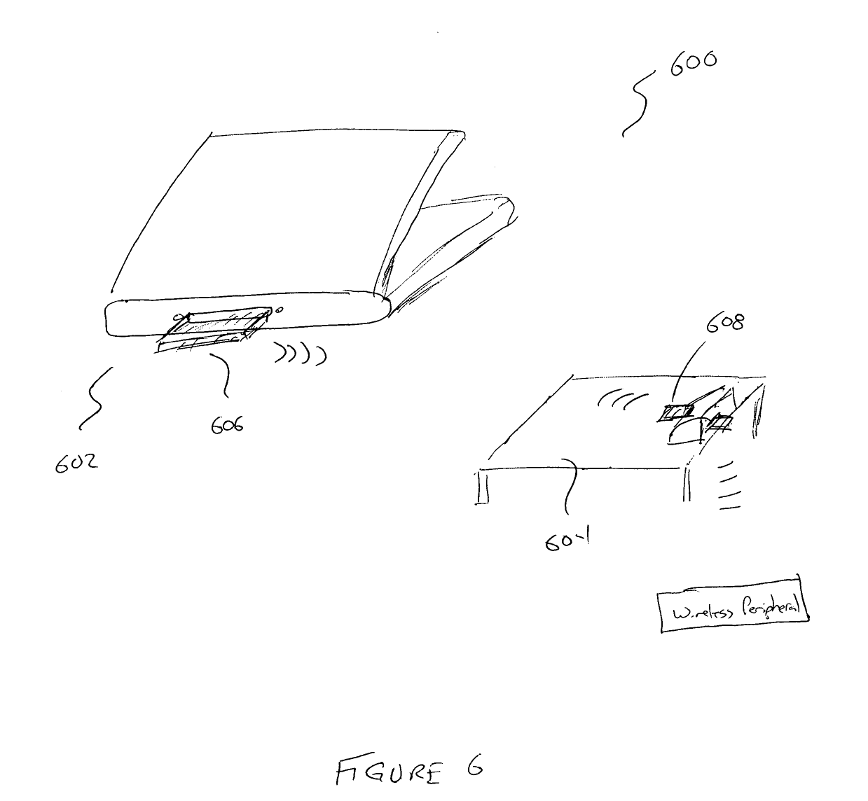

There is, of course, a significant install base of prior art laptops and docking stations. Therefore, in another embodiment of the present invention, the chipsets described above can be packaged in a “dongle” that can be plugged into those existing ports. This will alleviate the need to align and engage the port replicator. FIG. 6 illustrates this retrofit embodiment 600. A first dongle 606 is connected to the docking assembly on the rear of the laptop 602. A second dongle 608 is connected to the port replicator on the docking station 604.

In view of the number of wireless peripherals, it is also anticipated that the docking station could be equipped with a wireless transceiver for direct communication with the new wireless peripherals as well as the legacy devices. For example, the use of Bluetooth technology is increasingly prevalent in cell phones, keyboards and computer pointing devices. The docking station could also include a Bluetooth module to enable communications with these peripherals.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless computer docking system comprising:
(a) a computer having a first wireless transceiver;
(b) a docking station having a second wireless transceiver.

2. The docking system of claim 1 wherein the docking station further comprises a at least one legacy I/O ports.

3. The docking system of claim 1 wherein the first wireless transceiver is an ultra wideband transceiver.

4. The docking system of claim 1 wherein the second wireless transceiver is an ultra wideband transceiver.

5. The docking system of claim 1 wherein the computer is a laptop, notebook, or tablet computer, or PDA-type device.

6. The docking system of claim 1 wherein the computer further comprises a UWB wireless chipset coupled to a PC bridge or I/O chipset by a system bus.

7. The docking system of claim 1 wherein the docking station further comprises a UWB wireless chipset coupled to a PC bridge or I/O chipset by a system bus.

8. The docking system of claim 7 wherein the docking station further comprises a microcontroller to handle data transfers and bus arbitration. Wireless Docking Station

9. A method of associating a laptop computer to at least one peripheral comprising the steps of:
(a) placing the laptop in the proximity of a docking station; and
(b) creating an ultrawideband wireless connection between the laptop and the docking station, wherein the base station is coupled to the at least one peripheral.

10. The method of claim 9 wherein step (b) further comprises coupling the docking station to a monitor.

11. The method of claim 9 wherein step (b) further comprises coupling the docking station to a keyboard.

12. The method of claim 9 wherein step (b) further comprises coupling the docking station to a computer mouse.

13. The method of claim 9 wherein step (b) further comprises coupling the docking station to a local area network.

14. The method of claim 9 wherein step (b) further comprises coupling the docking station to a printer.

15. The method of claim 9 wherein step (b) further comprises coupling the docking station to a peripheral by a wired connection.

16. The method of claim 9 wherein step (b) further comprises coupling the docking station to a peripheral by a wireless connection.

17. A wireless computer docking system comprising:
(a) a computer having a first connector for coupling to a docking station
(b) the docking station having a second connector for mating with the first connector;
(c) a first transceiver for coupling to the first connector; and
(d) a second transceiver for coupling to the second connector.

18. The docking system of claim 17 wherein the docking station further comprises a at least one legacy I/O ports.

19. The docking system of claim 17 wherein the first transceiver is an ultra wideband transceiver.

20. The docking system of claim 17 wherein the second transceiver is an ultra wideband transceiver.
